(19) United States
(12) Patent Application Publication
(10) Pub. No.: US 2013/0332265 A1
(43) Pub. Date: Dec. 12, 2013

(54) TRANSACTION INCENTIVE AND COMMISSION DISTRIBUTION SYSTEM

(71) Applicants: Daniel Maguire Sossaman, II, Philadelphia, PA (US); David Ellis Richman, Philadelphia, PA (US); Edward Ralph Case, II, Philadelphia, PA (US); Kerry Gerard Zeida, Philadelphia, PA (US)

(72) Inventors: Daniel Maguire Sossaman, II, Philadelphia, PA (US); David Ellis Richman, Philadelphia, PA (US); Edward Ralph Case, II, Philadelphia, PA (US); Kerry Gerard Zeida, Philadelphia, PA (US)

(73) Assignee: GIVE TO BENEFIT, INC., Penn Valley, PA (US)

(21) Appl. No.: 13/911,546

(22) Filed: Jun. 6, 2013

Related U.S. Application Data
(60) Provisional application No. 61/657,338, filed on Jun. 8, 2012.

(51) Int. Cl. G06Q 30/02

(52) U.S. Cl. CPC G06Q 30/0242
USPC 705/14.45

(57) ABSTRACT

An electronic transaction incentive and commission distribution system, and the method based on the system, for receiving point-of-sale transaction data used in managing purchase transaction data and the electronic distribution of purchase commissions from a supplier to a marketing firm for the sale of the supplier's products to a recipient. The system also includes donors providing donations for the purchase of the supplier's products by the recipient.

### CROSS-REFERENCE TO RELATED APPLICATIONS

This application claims the benefit under 35 U.S.C. Section 119 of United States Provisional Application No. 61/657,338 filed Jun. 8, 2012.

### FIELD OF THE INVENTION

The present invention relates to an electronic system and method for receiving point-of-sale transaction data used in managing purchase transactions and the electronic distribution of purchase commissions from a supplier to a marketing firm.

### BACKGROUND OF THE INVENTION

Funding mechanisms currently in use are designed to provide funding to a non-profit entity via a public appeal campaign (a/k/a Crowd Funding Campaign) on the Internet and are organized so that the non-profit entity utilizes a funding technology platform to create a campaign that requests individual donors to donate dollars toward a project or goal.

There are several financial models for the handling of funds in such transactions.

Each financial model currently in use involves three types of Actors: A Donor, a Fundraiser and a Recipient Non-Profit Entity. Funds travel from the Donor to the Fundraiser to the Recipient.

In financial models currently in use, the Recipient or the Fundraiser creates a marketing campaign intended to attract donors to fund the Project. Although these marketing campaigns can use any marketing channel, Social Media are preferred.

In funding mechanisms currently in use, a portion of the donations must be allocated to the fundraiser. Therefore, it would be desirable to develop a transaction system by which the fundraiser, i.e., a for-profit marketing firm, receives commissions from a source other than donations.

### BRIEF SUMMARY OF THE INVENTION

In accordance with the invention, an electronic transaction incentive and commission distribution system, and the method based on the system, distribute commissions from a single supplier to a marketing firm for sales of products by the supplier consequent to the marketing firm's efforts. The transactions involve the purchase of the products by a single recipient from funds provided by at least one donor. The term “product” includes goods, services, and credits for goods and services offered by the supplier.

The system includes the step of designating through the marketing firm the supplier and recipient of at least one product from the supplier. An electronic database is organized to contain records identifying the at least one product, the price of the product and the commission from the supplier to the marketing firm for the sale of the product by the supplier to the recipient. An online campaign is carried out by the marketing firm and/or the recipient to attract donors to contribute funds to purchase the products. The contributions are placed in an escrow or holding account in an arrangement whereby an independent third party receives the money.

In a preferred embodiment, a processing terminal records the donations and the transaction data for the purchase of the products. The transaction data is electronically transmitted from the processing terminal to a commission management processor connected to the electronic database. A commission is determined for the marketing firm on the basis of the product purchase data recorded in the processing terminal.

### BRIEF DESCRIPTION OF THE DRAWINGS

The foregoing Brief Summary of the Invention, as well as the following Detailed Description of the Invention, will best be understood in conjunction with the attached drawings, in which:

FIG. 1 is a block diagram of the electronic transaction system according to a preferred embodiment of the invention.

FIG. 2 is a block diagram of a preferred embodiment of additional features of the transaction system disclosed in FIG. 1.

### DETAILED DESCRIPTION OF THE INVENTION

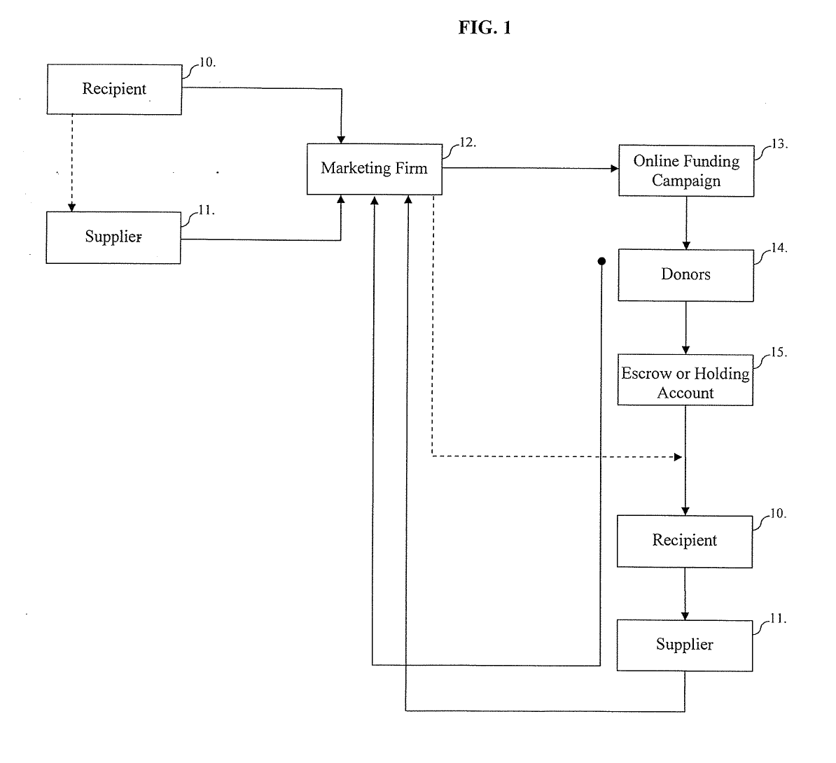

Referring now to FIG. 1, there is shown an exemplary transaction incentive and commission system according to the invention.

As described more fully herebelow, a for-profit marketing firm 12 matches a non-profit recipient 10 which needs selected products with a supplier 11 that is preferably for-profit and which is designated as the exclusive source of the products.

The term “product” includes both goods and services offered by the supplier and credits for goods and services offered by the supplier. Credits for goods and services would include, for example, a store credit, a gift certificate or a gift card. The credit may be utilized in association with other discounts or incentives offered by the supplier to the recipient.

The supplier 11 determines the market price for the products. The for-profit marketing firm creates an online funding campaign 13 to attract the donors 14 who provide donations for purchase of the product by the recipient. Alternatively, the online funding campaign 13 may be carried out by the recipient 10, and/or or both the marketing firm 12 and the recipient 10.

As disclosed in FIG. 1, the donations are transmitted to an escrow or holding account 15 in an arrangement whereby an independent third party receives the money.

In one embodiment, donations in the escrow or holding account can be accessed by the recipient and/or the marketing firm when the funds in the account equal the price of a product.

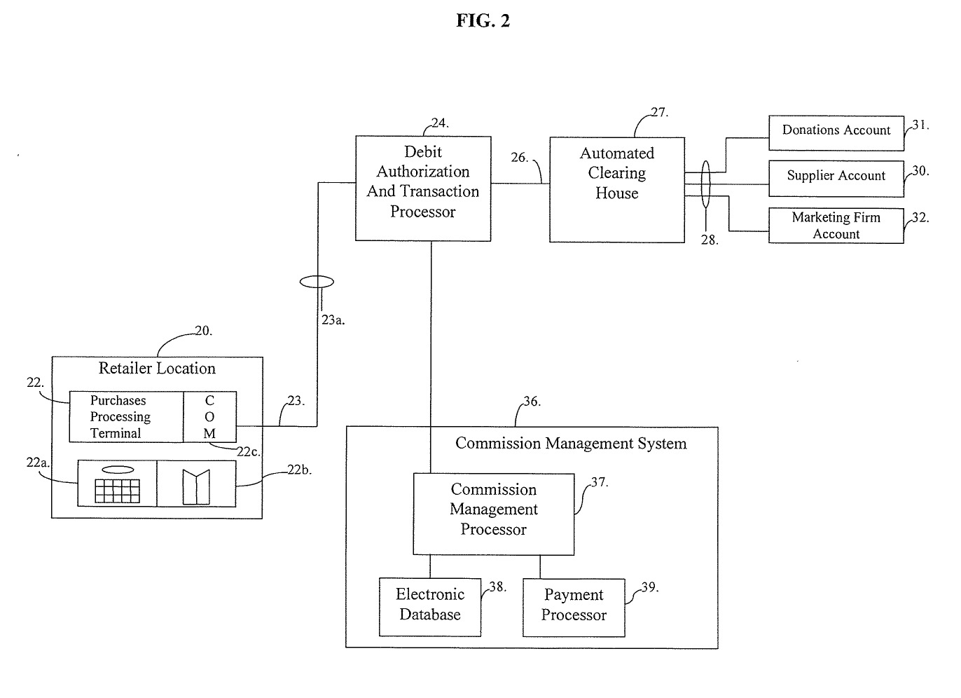

In another embodiment, the third party in charge of the escrow or holding account is a retailer, preferably an e-commerce retailer. According to this embodiment, the payments are transmitted to the retailer 20. The retailer processes the payments, purchases the products from the supplier on behalf of the recipient, pays the supplier, calculates the commission due to the marketing firm and pays the marketing firm. An exemplary transaction and commission system disclosing additional features according to the invention is shown in FIG. 2.

By prior arrangement between the for-profit marketing firm and the supplier, the supplier agrees to provide the for-profit marketing firm a commission based upon a percentage of the purchase price for the product or a fixed amount per purchase.

Information as to the identity of the donor, the supplier, the marketing firm, the recipient, the marketing price of the products and the commissions are provided to the retailer 20.

Referring now to FIG. 2, a purchase-processing terminal (PPT) 22 is situated at retail location(s) 20. The location(s) may comprise a retail site or an operator who takes orders by phone for a catalog or a computer site used to sell products through a network.

The retailer downloads pertinent information about the identities of the donor, the supplier and the recipient, and the marketing price of the product[s] to the purchase-processing terminal 22 under its control.

The purchase-processing terminal 22 is a conventional apparatus including data entry means such as a keyboard 22a, and a digital memory for the temporary storage of data on the products, the supplier, the donor, the marketing firm, the recipient, the market prices of the products and the amounts donated by each donor.

The for-profit marketing firm 12 or supplier 11 determines the market price for the products. The marketing firm 12 and/or the recipient 10 create an online funding campaign 13. The campaign requests payments to a purchase-processing terminal 22. The purchase-processing terminal is under the control of a retailer 15, which may also display the products.

As noted above, the purchase-processing terminal 22 is a conventional apparatus, including data entry means, such as a keyboard 22a and a magnetic stripe reader 22b, for acquiring data pertaining to a purchase; a digital memory (not shown) for temporarily storing purchase data; and an electronic communication interface 22c such as a modem, for communicating donations and purchase data, and for receiving an authorization signal for a donation or purchase.

When a donor wishes to support a purchase in connection with retail location(s) 20, the donor provides a payment in a form such as a debit card, a credit card or a check by which the donor's account number is entered into the memory of the purchase-processing terminal 22 via the magnetic stripe reader 22b. The amount of the purchase is entered into the memory of the POS terminal via the keyboard 22a (or other data entry means, such as a barcode scanner). The terminal 22 becomes operative to activate the electronic communication interface 22c to establish an electronic data connection 23 with a debit authorization and transaction processor 24. In embodiments wherein the communication interface 22c comprises a modem, the data connection 23 may be a telephonic connection.

In other embodiments, alternative known systems of electronic data transmission may be employed to establish the data connection 23. The purchase-processing terminal 22 is operative to transmit purchase data, including a donor account number, the amount of the purchase, and the identity of the retailer, to the authorization and transaction processor 24. The processor 24 is preferably housed at a site remote from the respective retail location(s), and is further configured to establish electronic data connections with each of the retail locations. The processor 24 is operative for receiving purchase data and for determining, for each purchase, whether to issue an authorization signal in response to the received purchase data. Such a determination may be made, for example, on the basis of risk data maintained by the processor 24 and relating to the donors, for assessing whether there is an acceptably low risk of default on the amount of the purchase. Alternatively, the authorization processor may make such a determination by obtaining access to the donations account balance.

If the proposed purchase is approved, the authorization processor 24 transmits an electronic authorization signal along the data connection 23 to the purchase-processing terminal 22 which, in turn, signifies receipt of the authorization signal for the recipient to make the purchase.

When a purchase is approved by the processor 24, the processor 24 then establishes a data connection 26 with an automated clearing house (ACH) processor 27. The ACH processor 27 is preferably established at a remote site relative to the authorization processor 24. The ACH processor 27 is further connected with an electronic funds transfer network 28 for effecting electronic transfers of funds among a supplier account 30, and an account 31 recording the donations. For each purchase, the authorization processor 24 instructs the ACH processor 27 to effect the following electronic fund transfers: a debit to the donations account 31 in the amount of the purchase, a credit to the supplier account 30 in the amount of the purchase.

In addition to instructing the ACH processor 27 to effect transfers of funds, the authorization processor 24 is configured to transmit purchase data to a commission management system 36 maintained by the retailer. The commission management system 36 comprises a commission management processor 37, an electronic database 38 for data as to commissions from the supplier to the marketing firm, and a payment processor 39 such as an automated printing and mailing facility for effecting payments from the supplier to the marketing firm.

After the commission management processor 37 has determined a commission to be paid to a marketing firm, the member identification data and the amount of the commission are transmitted to a payment processor subsystem 39. In a preferred embodiment, the payment processor subsystem 39 comprises an automated printer/mailer for printing a commission check to be mailed to the marketing firm.

In another embodiment, the payment processor subsystem 39 may effect an electronic fund transfer of the commission amount from the supplier account 30 to the marketing firm account 32, and print a statement for mailing to the marketing firm.

In another embodiment, the retail location(s) 20 is an Internet web server capable of processing e-commerce transactions. In such an embodiment, the “point-of-sale” purchase-processing terminal 22 is a remote computer by which a user connects to the retail site, selects merchandise, and enters appropriate purchase information. Such information is then relayed to the authorization processor 24, such that the payment device functions as herein otherwise described, with the functions of the purchase-processing terminal 22 distributed among the retailer's web server and the user's computer or other device capable of establishing a connection to the Internet 23a, such as a personal digital assistant or digital cellular telephone. The retail location(s) may further comprise a web site depicting Internet retailers, such as an Internet mall capable of processing e-commerce transactions.

The terms employed hereinabove are terms of description, not limitation. The scope of the invention is intended to be defined by the following claim and equivalents thereunder. As can be appreciated, the invention is susceptible to variation within the skill of those knowledgeable in the pertinent art.

What is claimed is:

1. A transaction incentive and commission distribution system adapted to distribute commissions from one supplier to a marketing firm for sales of products of the supplier wherein said transactions also involve at least one donor and one recipient of the products, said system comprising the steps of:
designating through the marketing firm of the one supplier and one recipient of at least one product of the supplier;
organizing an electronic database to contain records identifying the at least one product and the commission from the supplier to the marketing firm for the sale of the product by the supplier;
attracting at least one donor to contribute funds to be used to purchase the supplier's products through an online marketing campaign by the marketing firm and/or the recipient;
recording the donations and transaction data for purchase of the supplier's products;
electronically transmitting the transaction data;
determining a commission for the marketing firm on the basis of product purchase data recorded; and
effecting a monetary payment in the amount of the commission value to the marketing firm.

2. The system as claimed in claim 1 wherein the transaction data is electronically submitted from a purchase processing terminal to a commission management processor connected to the electronic database.

3. The system as claimed in claim 2 wherein the commission management processor determines a commission to be paid to the marketing firm and after that determination is made, the amount of the commission is transmitted to a payment processor subsystem.

4. The system as claimed in claim 3 wherein the payment processor subsystem comprises an automated printer/mailer for printing a commission check to be mailed to the marketing firm.

5. The system as claimed in claim 3 wherein the payment processor subsystem effects an electronic fund transfer of the commission amount from a supplier account to a marketing firm account and generates a statement for mailing to the marketing firm.

6. The system as claimed in claim 2 wherein the purchase processing terminal is situated at a retail location.

7. The system as claimed in claim 6 wherein the retail location is an Internet web server capable of processing e-commerce transactions.

8. The system as claimed in claim 7 wherein the purchase processing terminal is a remote computer by which a user connects to a retail site, selects merchandise, and enters appropriate purchase information.

9. The system as claimed in claim 1 wherein the records contained in the electronic database include the price of the product.

10. The system as claimed in claim 1 wherein the at least one donor comprises donors.

11. The system as claimed in claim 1 wherein the recipient is a non-profit entity.

12. The system as claimed in claim 1 wherein the step of recording the donations and transaction data for purchase of the supplier's products is carried out by operating a purchase processing terminal.

13. A transaction incentive and commission distribution system adapted to distribute commissions from one supplier to a marketing firm for sales of products of the supplier wherein said transactions also involve at least one donor and one recipient of the products, said system comprising the steps of:
designating through the marketing firm of the one supplier and one recipient of at least one product of the supplier;
organizing an electronic database to contain records identifying the at least one product, the price of the product and the commission from the supplier to the marketing firm for the sale of the product by the supplier;
attracting at least one donor to contribute funds to be used to purchase the supplier's products through an online marketing campaign by the marketing firm and/or the recipient;
operating a purchase-processing terminal to record the donations and transaction data for purchase of the supplier's products;
electronically transmitting the transaction data from the purchase-processing terminal to a commission management processor connected to the electronic database;
determining a commission for the marketing firm on the basis of product purchase data recorded in the processing terminal; and
effecting a monetary payment in the amount of the commission value to the marketing firm.

14. The system as claimed in claim 13 wherein the commission management processor determines a commission to be paid to the marketing firm and after that determination is made, the amount of the commission is transmitted to a payment processor subsystem.

15. The system as claimed in claim 14 wherein the payment processor subsystem comprises an automated printer/mailer for printing a commission check to be mailed to the marketing firm.

16. The system as claimed in claim 14 wherein the payment processor subsystem effects an electronic fund transfer of the commission amount from a supplier account to a marketing firm account and generates a statement for mailing to the marketing firm.

17. The system as claimed in claim 14 wherein the purchase processing terminal is situated at a retail location.

18. The system as claimed in claim 14 wherein the purchase processing terminal is a remote computer by which a user connects to a retail site, selects merchandise, and enters appropriate purchase information.

19. A transaction incentive and commission distribution system adapted to distribute commissions from one supplier to a marketing firm for sales of products of the supplier comprising goods, services and credits for goods and services, wherein said transactions also involve at least one donor and one recipient of the products, said system comprising the steps of:
designating through the marketing firm of the one supplier and one recipient of at least one product of the supplier;
organizing an electronic database to contain records identifying the at least one product, the price of the product and the commission from the supplier to the marketing firm for the sale of the product by the supplier;
attracting donors to contribute funds used to purchase the supplier's products through an online marketing campaign by the marketing firm and/or the recipient;
operating a purchase-processing terminal to record the donations and transaction data for purchase of the supplier's products;
electronically transmitting the transaction data from the purchase-processing terminal to a commission management processor connected to the electronic database;
determining a commission for the marketing firm on the basis of product purchase data recorded in the processing terminal;
effecting a monetary payment in the amount of the commission value to the marketing firm.

20. The system as claimed in claim 19 wherein the credits for goods and services comprise store credits, gift certificates and gift cards.
